(19) United States
(12) Patent Application Publication
(10) Pub. No.: US 2026/0019738 A1
(43) Pub. Date: Jan. 15, 2026

(54) LOUDSPEAKER AND ELECTRONIC DEVICE

(71) Applicant: AAC Technologies Pte. Ltd., Singapore (SG)

(72) Inventors: Juha Backman, Tampere (FI); Timo Lamberg, Tampere (FI)

(21) Appl. No.: 18/769,335

(22) Filed: Jul. 10, 2024

(51) Int. Cl. H04R 1/28; H01P 7/06; H04R 1/02

(52) U.S. Cl. CPC H04R 1/2826; H01P 7/06; H04R 1/025

(57) ABSTRACT

Disclosed is a loudspeaker and an electronic device. The loudspeaker includes: a loudspeaker housing having a receiving cavity; a loudspeaker body accommodated in the receiving cavity separated as a front cavity and a rear cavity, the front cavity is in communication with outside of the loudspeaker housing; and a resonator accommodated in the rear cavity having at least one cavity part and at least one port part. The first side of the resonator corresponds to one port part, the other side of the resonator corresponds to one cavity part or the other port part. The present disclosure can reduce space occupied by the loudspeaker, flow loss and flow noise, and the acoustical mass of the port part adds to that of the resonator, so that any acoustic resonance induced by the interaction between the resonator and the port part is greater than the operating frequency range of the loudspeaker.

### TECHNICAL FIELD

The present disclosure relates to the technical field of electricity-acoustics conversion, and in particular, to a speaker and an electronic device.

### BACKGROUND

In the prior art, the use of multiple resonators to increase low frequency efficiency and extend the low frequency bandwidth of a loudspeaker is well known. The challenge in applying these principles to compact and portable devices, however, is the considerable physical space required by conventional constructions of coupled cavity loudspeakers, with practical implementation challenges when the structure of coupled cavity speakers is scaled to the typical size of most portable devices.

### SUMMARY

The object of the present disclosure is to provide a loudspeaker and an electronic device, to solve the technical problem in the prior art.

In the first aspect, the present disclosure provides a loudspeaker, including a loudspeaker housing, a loudspeaker body and a resonator.

The loudspeaker housing has a receiving cavity.

The loudspeaker body is accommodated in the receiving cavity. The receiving cavity is separated by the loudspeaker body into a front cavity and a rear cavity. The loudspeaker body is provided with a sound hole. The front cavity is in communication with the outside of the loudspeaker housing via the sound hole.

The resonator is accommodated in the rear cavity. The rear cavity has at least one cavity part and at least one port part inside. The speaker body and a vibration direction of the resonator both extend along a first direction. The at least one port part extends along a second direction. A preset angle is formed between the first direction and the second direction. A first side of the resonator is correspondingly provided with one port part, and the other side of the resonator is provided with one cavity part or another port part.

As an improvement, in a loudspeaker as described above, the cavity part includes a first cavity, a second cavity and a third cavity, the port part includes a first port and a second port, and the resonator includes a first resonator, a second resonator and a third resonator.

The loudspeaker body is provided corresponding to the first cavity.

A first side of the first resonator is provided corresponding to the first cavity, and a second side of the first resonator is provided corresponding to the first port, and the first port is in communication with the second cavity.

A first side of the second resonator is provided corresponding to the second cavity, a second side of the second resonator is provided corresponding to the second port, and the second port is in communication with the third cavity.

A first side of the third resonator is provided corresponding to the third cavity, and a second side of the third resonator is exposed to the outside of the loudspeaker housing.

As an improvement, in a loudspeaker as described above, a projection of the sound hole in the first direction falls on the first resonator.

As an improvement, in a loudspeaker as described above, the cavity part includes a first cavity and a second cavity, the port part includes a first port, a second port, and a third port, and the resonator includes a first resonator and a second resonator.

The loudspeaker body is provided corresponding to the first cavity, and the first cavity is in communication with the first port.

The first side of the first resonator is provided corresponding to the first port, and the second side of the first resonator is provided corresponding to the second port, and the second port is in communication with the second cavity.

The first side of the second resonator is provided corresponding to the second cavity, and the second side of the second resonator is provided corresponding to the third port.

As an improvement, in a loudspeaker as described above, the cavity part includes a first cavity and a second cavity, the port part includes a first port, a second port, a third port, a third port, a fourth port, a fifth port and a sixth port, the resonator includes a first resonator, a second resonator, a third resonator and a fourth resonator.

The loudspeaker body is provided corresponding to the first cavity, the first cavity is in communication with the first port and the second port, respectively, the first port and the second port are symmetrically arranged at two opposite sides of the third port, the third port is in communication with the second cavity, the fourth port and the fifth port are symmetrically arranged at two opposite sides of the second cavity, and the fifth port and the fourth port are both in communication with the sixth port.

A first side of the first resonator is provided corresponding to the first port, and a second side of the first resonator is provided corresponding to the third port.

A first side of the second resonator is provided corresponding to the second port, and a second side of the second resonator is provided corresponding to the third port.

A first side of the third resonator is provided corresponding to the second cavity, and a second side of the third resonator is provided corresponding to the fourth port.

A first side of the fourth resonator is provided corresponding to the second cavity, and a second side of the fourth resonator is provided corresponding to the fifth port.

As an improvement, in a loudspeaker as described above, the first cavity, the third port, the second cavity, and the sixth port have axes coincide with each other.

As an improvement, in a loudspeaker as described above, the preset angle is 90°.

As an improvement, in a loudspeaker as described above, a length of the port part in the first direction is less than a length of the port part in the second direction.

As an improvement, in a loudspeaker as described above, an arc guide surface is provided on each of two inner surfaces on opposite sides of the port part to form a port part with a Venturi tube structure.

In the second aspect, the present disclosure provides an electronic device, including the loudspeaker as described above.

Compared with the prior art, in the present disclosure, at least one side of the resonator is provided with a port part, the port part is of a long and narrow groove structure, the resonator is provided at a lateral surface of the port part, and a space between the resonator and another corresponding lateral surface of port part is relatively small. In this case, on the one hand, the space occupied by the loudspeaker can be reduced, facilitating application to compact portable devices, and more practical design parameters for the port part and the resonator (larger port area and smaller resonator acoustical mass) can be adopted; on another hand, flow loss can be reduced, and flow noise can be reduced; and on another hand, the acoustical mass of the port part can add to that of resonator, such that any acoustic resonance induced by the interaction between the resonator and the port part is greater than the operating frequency range of the loudspeaker, so as to improve the high frequency reproduction of the loudspeaker, reduce the intermodulation distortion of the loudspeaker, and ultimately improve the acoustical mass of the loudspeaker in the electronic device.

### BRIEF DESCRIPTION OF DRAWINGS

FIG. 1 is a structural schematic diagram of a loudspeaker as described in the first embodiment of the present disclosure.

FIG. 2 is a structural schematic diagram of a loudspeaker as described in the second embodiment of the present disclosure.

FIG. 3 is a structural schematic diagram of a loudspeaker as described in the third embodiment of the present disclosure.

FIG. 4 is a structural schematic diagram of a port part with an arc guide surface as described in an embodiment of the present disclosure.

FIG. 5 is a structural schematic diagram of the loudspeaker with an arc guide surface as described in an embodiment of the present disclosure.

Reference signs: 1-loudspeaker housing, 2-loudspeaker body, 3-front cavity, 4-rear cavity, 5-first cavity, 6-second cavity, 7-third cavity, 8-first port, 9-second port, 10-third port, 11-fourth port, 12-fifth port, 13-sixth port, 14-first resonator, 15-second resonator, 16-third resonator, 17-fourth resonator, 18-sound hole,19-arc guide surface;

D1-first direction;

D2-second direction.

### DESCRIPTION OF EMBODIMENTS

These embodiments described below with reference to the drawings are exemplary, and are used just to explain the present disclosure, but not to limit the present disclosure.

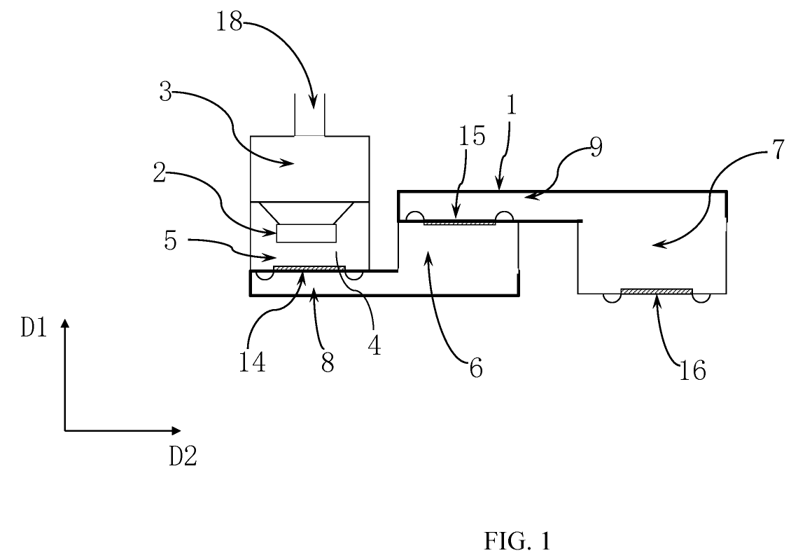

As shown in FIGS. 1 to 5, an embodiment of the present disclosure provides a loudspeaker including a loudspeaker housing 1 and a loudspeaker body 2 and a resonator provided within the loudspeaker housing 1.

The loudspeaker housing 1 includes a receiving cavity configured to accommodate the loudspeaker body 2 as well as at least one resonator.

The loudspeaker body 2 is accommodated in the receiving cavity, the loudspeaker body 2 is configured to vibrate to generate sound. The receiving cavity is separated by the loudspeaker body 2 as a front cavity 3 and a rear cavity 4. The loudspeaker housing 1 is provided with a sound hole 18. The front cavity 3 is in communication with the outside of the loudspeaker housing 1 via the sound hole18. In an embodiment, the loudspeaker body 2 may include structures such as a diaphragm, a sound coil and a magnetic circuit unit. Under the action of the magnetic circuit unit, the sound rings with varying current vibrate due to Ampere forces of different values, the vibration of the vibration drives the diaphragm to vibrate, and the vibration of the diaphragm forces the surrounding air to vibrate, so as to generate sound.

The resonator is accommodated in the rear cavity 4 to arrange the resonator in the propagation path of the sound wave. The resonator can be made of any material with appropriate mechanical properties. In an embodiment as described in the present disclosure, the resonator is a passive resonator.

In an embodiment of the present disclosure, there may be a plurality of resonators, of which the specific mass can be determined according to the actual situation, and is not limited herein. A rear cavity 4 is provided with at least one cavity part and at least one port part. The loudspeaker body 2 as well as the vibration direction of the resonator extend along the first direction D1, the resonator is coupled to the rear cavity 4, and provide acoustic impedance within the rear cavity 4. The acoustic impedance acts as an impedance match of the plane acoustic wave propagating along the rear cavity 4, so as to attenuate the high mode in the axis direction of the rear cavity 4. Further, the resonator is designed to concentrate such attenuation effect to high frequencies.

The port part extends along the second direction D2. A preset angle is formed between the first direction D1 and the second direction D2. The value range of the preset angle can be determined according to the actual situation, and is not limited herein. In an embodiment, the preset angle is 90°. In an embodiment as described in the present disclosure, the vibration direction of the loudspeaker body 2 is defined as the first direction D1, the normal direction of the vibration direction of the loudspeaker body 2 is defined as the second direction D2, and the first direction D1 and the second direction D2 are perpendicular to each other. The port part is of a long and narrow groove structure. A length of the port part in the first direction D1 is much less than a length of the port part in the second direction D2. The port part extends along the normal direction of the loudspeaker body 2.

In an embodiment of the present disclosure, the first side of the resonator is correspondingly provided with a port part, and the other side of the resonator is provided with one cavity part or another port part. The resonator is provided on a lateral surface of the port part. The space between the resonator and another corresponding lateral surface of port part is relatively small. In this case, on the one hand, the space occupied by the loudspeaker can be reduced, facilitating application to compact portable devices, and more practical design parameters for the port part and the resonator (larger port area and smaller resonator acoustical mass) can be adopted; on another hand, flow loss can be reduced, and flow noise can be reduced; and on another hand, the acoustical mass of the port part can add to that of resonator, such that any acoustic resonance induced by the interaction between the resonator and the port part is greater than the operating frequency range of the loudspeaker, so as to improve the high frequency reproduction of the loudspeaker, reduce the intermodulation distortion of the loudspeaker, and ultimately improve the acoustical mass of the loudspeaker in the electronic device.

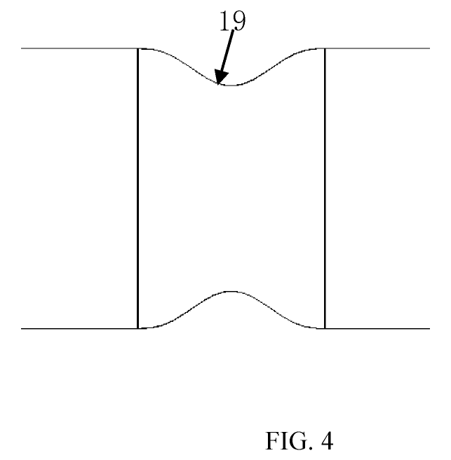

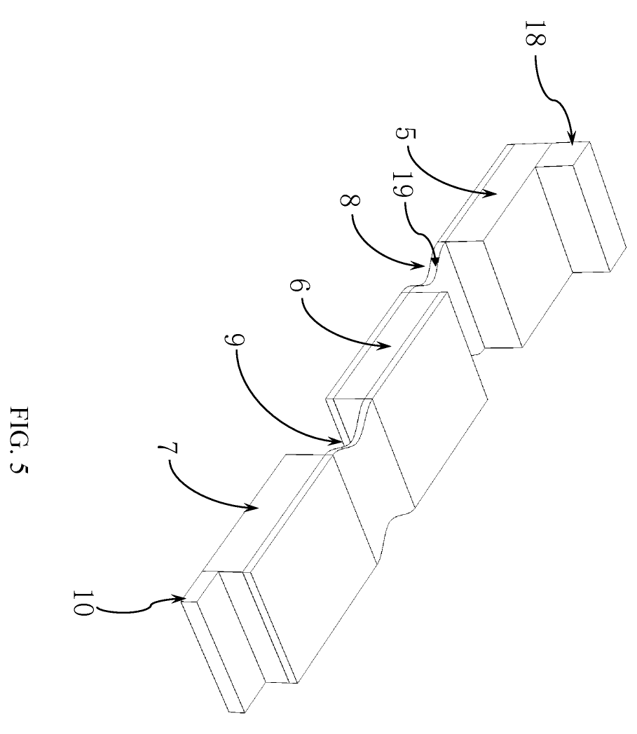

Referring to FIG. 4 and FIG. 5, as an improvement, an arc guide surface 19 is provided by convex on each of the two inner surfaces on two opposite sides of the port part, so as to form the port part with a Venturi tube structure. The inside of the port part is of a hallow cavity structure similar to a Venturi shape. Each of the two opposite sides of the arc guide surface 19 is connected to a straight line segment, and the arc guide surface 19 consists of a curved segment with gradually increasing diameters and a curved segment with gradually decreasing diameters, such that flow noise and distortion can be reduced while the sound waves are transmitted.

Several embodiments are listed below to further illustrate the structure of the loudspeaker of the present disclosure. One of ordinary skill in the art may know that more variation can be designed according to the following embodiments, all of which belong to the protection scope of the present disclosure.

### First Embodiment

As shown in FIG. 1, in this embodiment, the cavity part includes a first cavity 5, a second cavity 6, and a third cavity 7. The first cavity 5, the second cavity 6 and the third cavity 7 may have the same or different shapes and sizes, which are not limited herein. The port part includes a first port 8 and a second port 9. The first port 8 and the second port 9 may have the same or different shapes and sizes, which are not limited herein. Along the first direction D1, the length of each cavity in the cavity part is greater than the length of each port in the port part. The resonator includes a first resonator 14, a second resonator 15, and a third resonator 16. The first resonator 14, the second resonator 15 and the third resonator 16 are passive resonator.

The loudspeaker body 2 is provided corresponding to the first cavity 5, and the two opposite sides of the loudspeaker body 2 are the front cavity 3 and the first cavity 5, respectively.

The first side of the first resonator 14 corresponds to the first cavity 5. The second side of the first resonator 14 corresponds to the first port 8. The first port 8 is of a long and narrow groove structure. The groove structure extends along the second direction D2. The first resonator 14 is provided on one lateral wall body of the first port 8. The vibration direction of the first resonator 14 is perpendicular to the second direction D2. The distance between the other lateral wall body of the first port 8 and the first resonator 14 is relatively small, such that the acoustical mass of the first port 8 adds to that of the first resonator 14. In this case, any acoustic resonance induced by the interaction between the first resonator 14 and the first port 8 is greater than the operating frequency range of the loudspeaker, more practical design parameters for both the first port 8 and the first resonator 14 are adopted, the first port 8 may have a larger port area, and meanwhile, the first resonator 14 may have a smaller acoustical mass.

The first resonator 14 occupies only a part of the wall body of the first port 8. In the second direction D2, the end of the first port 8 facing away from the first resonator 14 is in communication with the second cavity 6. The second cavity 6 is arranged at a side of the loudspeaker body 2, and thus, on the first direction D1, can further compress the space occupied by the loudspeaker.

The first side of the second resonator 15 corresponds to the second cavity 6. The second side of the second resonator 15 corresponds to the second port 9. The second port 9 is of a long and narrow groove structure. The groove structure extends along the second direction D2. The second resonator 15 provided on a lateral wall body of the second port 9. The vibration direction of the second resonator 15 is perpendicular to the second direction D2. The distance between the other wall of the second port 9 and the second resonator 15 is relatively small, such that the acoustical mass of the second port 9 adds to that of the second resonator 15. In this case, any acoustic resonance induced by the interaction between the second resonator 15 and the second port 9 is greater than the operating frequency range of the loudspeaker, more practical design parameters for both the second port 9 and the second resonator 15 are adopted, the second port 9 may have a larger port area, and meanwhile, the second resonator 15 may have a smaller acoustical mass.

The second resonator 15 occupies only a part of the wall body of the second port 9. In the second direction D2, the end of the second port 9 facing away from the second resonator 15 is in communication with the third cavity 7, and the third cavity 7 is arranged at one side of the second cavity 6, and thus, in the first direction D1, can further compress the space occupied by loudspeaker.

The first side of the third resonator 16 corresponds to the third cavity 7, and the second side of the third resonator 16 is exposed to the outside of the loudspeaker housing 1.

The first port 8 and the second port 9 are arranged, so that there is minimal additional space between the first resonator 14 and the first port 8, and between the second resonator 15 and the second port 9. The end of the first port 8 is in communication with the second cavity 6, the end of the second port 9 is in communication with the third cavity 7, the volume of the cavity in which the sound waves propagate within the rear cavity 4 changes periodically, and the acoustic inductance of the first port 8 and the second port 9 adds by the mass of the first resonator 14 and the second resonator 15, thereby reducing the moving mass of the first resonator 14 and the second resonator 15.

In this embodiment, the projection of the sound hole 18 in first direction D1 falls on the first resonator 14, the cross-sectional area of the sound hole 18 should be less than the cross-sectional area of the first resonator 14, the coverage of the composite film of the first resonator 14 is broader, and the acoustic impedance provided by the composite film attenuates the high mode in the axis direction of the front cavity 3 more strongly.

### Second Embodiment

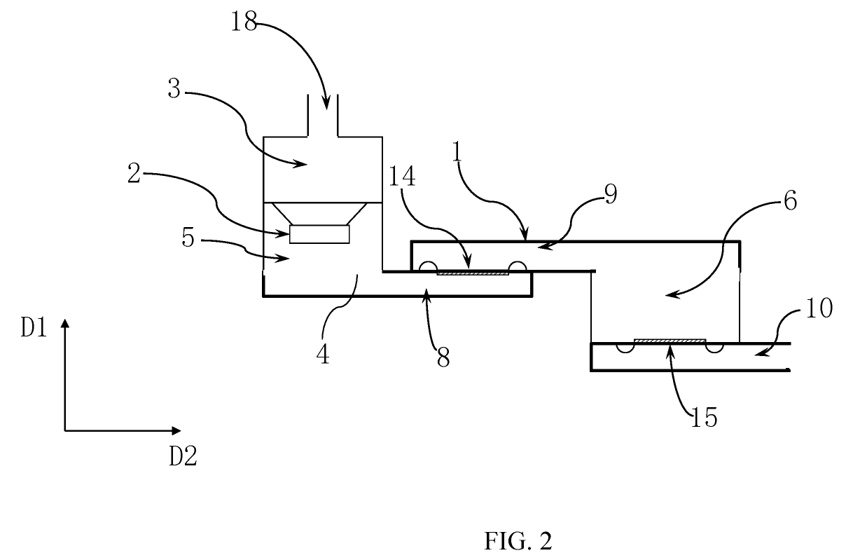

In this present embodiment, as shown in FIG. 2, the cavity part includes the first cavity 5 and the second cavity 6. The first cavity 5 and the second cavity 6 may have the same or different shapes and sizes, which are not limited herein. The port part includes a first port 8, a second port 9, and a third port 10. The first port 8, the second port 9 and the third port 10 may have the same or different shapes and sizes, which are not limited herein. Along the first direction D1, the length of each cavity in the cavity part is greater than the length of each port in the port part. The resonator includes the first resonator 14 and the second resonator 15. The first resonator 14 and the second resonator 15 are both passive resonators.

The loudspeaker body 2 corresponds to the first cavity 5. The two opposite sides of the loudspeaker body 2 are the front cavity 3 and the first cavity 5, respectively. The first cavity 5 is in communication with the first port 8. The first port 8 is provided at the lateral end of the first cavity 5 along the second direction D2. In the first direction D1, the projections of the first port 8 and the first cavity 5 do not overlap, thereby compressing the space occupied by the loudspeaker in the first direction D1, and making it more suitable for compact electronic devices.

The first side of the first resonator 14 corresponds to the first cavity 5. The second side of the first resonator 14 corresponds to the first port 8. The first port 8 is of a long and narrow groove structure. The groove structure extends along the second direction D2. The first resonator 14 is provided on one lateral wall body of the first port 8. The vibration direction of the first resonator 14 is perpendicular to the second direction D2. The distance between the other lateral wall body of the first port 8 and the first resonator 14 is relatively small, such that the acoustical mass of the first port 8 adds to that of the first resonator 14. In this case, any acoustic resonance induced by the interaction between the first resonator 14 and the first port 8 is greater than the operating frequency range of the loudspeaker, more practical design parameters for both the first port 8 and the first resonator 14 are adopted, the first port 8 may have a larger port area, and meanwhile, the first resonator 14 may have a smaller acoustical mass.

The first resonator 14 occupies only a part of the wall body of the first port 8. In the second direction D2, the end of the first port 8 facing away from the first resonator 14 is in communication with the second cavity 6. The second cavity 6 is arranged at a side of the loudspeaker body 2, and thus, on the first direction D1, can further compress the space occupied by the loudspeaker.

The first side of the second resonator 15 corresponds to the second cavity 6. The second side of the second resonator 15 corresponds to the third port 10. The third port 10 is a long and narrow groove structure. The groove structure extends along the second direction D2. The second resonator 15 is provided on a lateral wall body of the third port 10. The vibration direction of the second resonator 15 is perpendicular to the second direction D2. The distance between the other side wall of the third port 10 and the second resonator 15, such that the acoustical mass of the third port 10 adds to that of the second resonator 15. In this case, any acoustic resonance induced by the interaction between the second resonator 15 and the third port 10 is greater than the operating frequency range of loudspeaker, more practical design parameters can be adopted for both the third port 10 and the second resonator 15, the third port 10 can possess a larger port area, and meanwhile, the second resonator 15 can have a smaller acoustical mass.

The first port 8, the second port 9, and the third port 10, so that there is minimal additional space between the first resonator 14 and the first as well as the second port 8, 9, and between the second resonator 15 and the third port 10. The end of the first port 8 is in communication with the first cavity 5, the end of the second port 9 is in communication with the second cavity 6. The end of the third port 10 is in communication with the outside. The volume of the cavity in which the sound waves propagate within the rear cavity 4 changes periodically. The acoustic inductances of the first port 8, the second port 9 and the third port 10 add by the mass of the first resonator 14 and the second resonator 15, thereby reducing the moving mass of the first resonator 14 and the second resonator 15.

### Third Embodiment

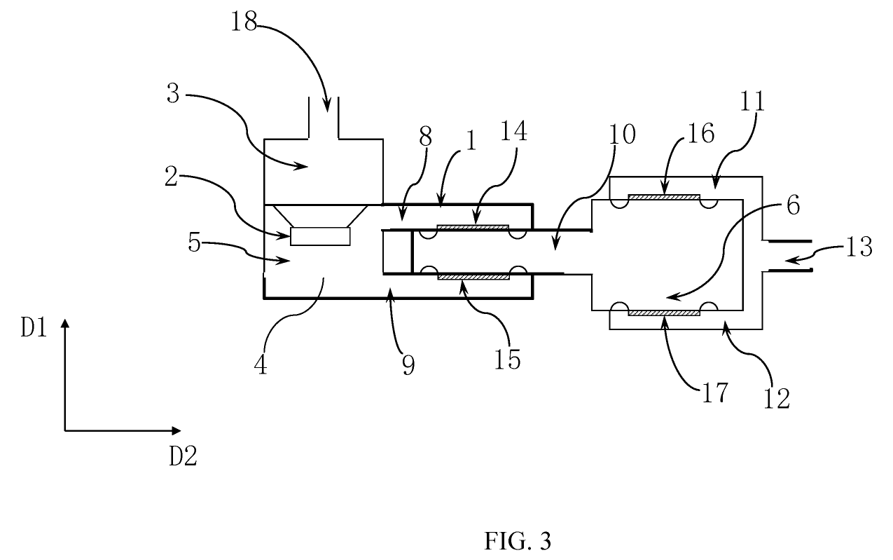

In this embodiment, as shown in FIG. 3, the cavity part includes a first cavity 5 and a second cavity 6. The port part includes a first port 8, a second port 9, a third port 10, a fourth port 11, a fifth port 12 and a sixth port 13. The resonator including a first resonator 14, a second resonator 15, and a third resonator 16 and a fourth resonator 17.

The loudspeaker body 2 corresponds to the first cavity 5, the first cavity 5 is in communication with the first port 8 and the second port 9, respectively. Along the second direction D2, the first port 8, the second port 9 and the third port 10 are all arranged at the lateral end of the first cavity 5. The first port 8 and the second port 9 are symmetrically arranged at two opposite sides of the third port 10. The third port 10 is in communication with the second cavity 6. Along the first direction D1, the fourth port 11 and the fifth port 12 are symmetrically arranged at two opposite sides of the second cavity 6. The fifth port 12 and the fourth port 11 are both in communication with the sixth port 13. The axes of the first cavity 5, the third port 10, the second cavity 6 and the sixth port 13 coincide each other, so as to increase symmetry and reduce rocking motion, and facilitate reducing the flow loss and reducing the flow noise.

The first side of the first resonator 14 corresponds to the first port a. The second side of the first resonator 14 corresponds to the third port 10. The first port 8 and the third port 10 are both of long and narrow groove structures. The groove structures extend along the second direction D2. The first resonator 14 is provided on one lateral wall body shared by the first port 8 and the third port 10. The vibration direction of the first resonator 14 is perpendicular to the second direction D2. The distance between the other lateral wall body shared by the first port 8 and the third port 10 and the first resonator 14 is relatively small, such that the acoustical masses of the first port 8 and the third port 10 add to that of the first resonator 14. In this case, any acoustic resonance induced by the interaction between the first resonator 14 and the first port 8 as well as the third port 10 is greater than the operating frequency range of the loudspeaker, more practical design parameters for both the first port 8, the third port 10 and the first resonator 14 are adopted, the first port 8 and the third port 10 may have a larger port area, and meanwhile, the first resonator 14 may have a smaller acoustical mass.

The first side of the second resonator 15 corresponds to the second port 9. The second side of the second resonator 15 corresponds to the third port 10, and the second port 9 and the third port 10 are both of long and narrow groove structures. The groove structures extend along the second direction D2. The second resonator 15 is provided on a lateral wall body shared by the second port 9 and the third port 10. The vibration direction of the second resonator 15 is perpendicular to the second direction D2. The distance between the other side wall shared by the second port 9 and the third port 10 and the second resonator 15, such that the acoustical masses of the second port 9 and the third port 10 add to that of the first resonator 14. In this case, any acoustic resonance induced by the interaction between the second resonator 15 and the second port 9 as well as the third port 10 is greater than the operating frequency range of loudspeaker, more practical design parameters can be adopted for both the second port 9, the third port 10 and the second resonator 15, the second port 9 and the third port 10 can possess a larger port area, and meanwhile, the first resonator 14 can have a smaller acoustical mass.

The first side of the third resonator 16 corresponds to the second cavity 6. The second side of the third resonator 16 corresponds to the fourth port 11. The fourth port 11 is of a long and narrow groove structure. The groove structure extends along the second direction D2. The third resonator 16 is provided on a lateral wall body of the fourth port 11. The vibration direction of the third resonator 16 is perpendicular to the second direction D2. The distance between the other side wall of the fourth port 11 and the third resonator 16 is relatively small, such that the acoustical mass of the fourth port 11 adds to that of the third resonator 16. In this case, any acoustic resonance induced by the interaction between the third resonator 16 and the fourth port 11 is greater than the operating frequency range of the loudspeaker, more practical design parameters can be adopted for both the fourth port 11 and the third resonator 16, the fourth port 11 can have a larger port area, and meanwhile, the third resonator 16 can have a smaller acoustical mass.

The first side of the fourth resonator 17 corresponds to the second cavity 6. The second side of the fourth resonator 17 corresponds to the fifth port 12. The fifth port 12 is of a long and narrow groove structure. The groove structure extends along the second direction D2. The fourth resonator 17 is provided on a lateral wall body of the fifth port 12. The vibration direction of the fourth resonator 17 is perpendicular to the second direction D2. The distance between the other wall of the fifth port 12 and the fourth resonator 17 is relatively small, such that the acoustical mass of the fifth port 12 adds to that of the fourth resonator 17. In this case, any acoustic resonance induced by the interaction between the fourth resonator 17 and the fifth port 12 is greater than the operating frequency range of the loudspeaker, more practical design parameters can be adopted for both the fifth port 12 and the fourth resonator 17, the fifth port 12 can have a larger port area, and meanwhile, the fourth resonator 17 can have a smaller acoustical mass.

In this embodiment, the first resonator 14 and the second resonator 15 are symmetrically arranged along the first direction D1, and the third resonator 16 and the fourth resonator 17 are symmetrically arranged along the first direction D1. A pair of resonator can be mechanically connected to each other to increase symmetry and reduce rocking motion, thereby eliminating the device vibration caused by the recoil force of the resonator.

Based on the above embodiments, the present disclosure further provides an electronic device, including, but not limited to, a mobile or fixed terminal device with a loudspeaker, such as a mobile phone, a tablet computer, a laptop computer, a wearable device, a virtual reality device, Bluetooth earphones or an on-board device.

The construction, characteristics and effects of the present disclosure are explained in detail according to the embodiments shown in the drawings. The above mentioned contents are just preferable embodiments of the present disclosure. However, the present disclosure does not define the scope of implementation as shown in the drawings. Any change made under the ideas of the present disclosure, or any modified equivalent embodiment of the equivalent change without departing from the spirit of the specification and drawings shall fall within the protection scope of the present disclosure.

What is claimed is:

1. A loudspeaker, comprising:
a loudspeaker housing having a receiving cavity;
a loudspeaker body accommodated in the receiving cavity, wherein the receiving cavity is separated by the loudspeaker body into a front cavity and a rear cavity, the loudspeaker body is provided with a sound hole, and the front cavity is in communication with outside of the loudspeaker housing via the sound hole; and
a resonator accommodated in the rear cavity, wherein the rear cavity comprises at least one cavity part and at least one port part inside, the speaker body and a vibration direction of the resonator both extend along a first direction, the at least one port part extends along a second direction, a preset angle is formed between the first direction and the second direction, a first side of the resonator is provided with one port part, and the other side of the resonator is provided with one cavity part or another port part.

2. The loudspeaker as described in claim 1, wherein the cavity part comprises a first cavity, a second cavity and a third cavity, the port part comprises a first port and a second port, and the resonator comprises a first resonator, a second resonator and a third resonator;
wherein the loudspeaker body is provided corresponding to the first cavity;
wherein a first side of the first resonator is provided corresponding to the first cavity, and a second side of the first resonator is provided corresponding to the first port, and the first port is in communication with the second cavity;
wherein a first side of the second resonator is provided corresponding to the second cavity, a second side of the second resonator is provided corresponding to the second port, and the second port is in communication with the third cavity; and
wherein a first side of the third resonator is provided corresponding to the third cavity, and a second side of the third resonator is exposed to the outside of the loudspeaker housing.

3. The loudspeaker as described in claim 1, wherein a projection of the sound hole in the first direction falls on the first resonator.

4. The loudspeaker as described in claim 1, wherein the cavity part comprises a first cavity and a second cavity, the port part comprises a first port, a second port, and a third port, and the resonator comprises a first resonator and a second resonator;
wherein the loudspeaker body is provided corresponding to the first cavity, and the first cavity is in communication with the first port;
wherein a first side of the first resonator is provided corresponding to the first port, and a second side of the first resonator is provided corresponding to the second port, and the second port is in communication with the second cavity; and
wherein a first side of the second resonator is provided corresponding to the second cavity, and a second side of the second resonator is provided corresponding to the third port.

5. The loudspeaker as described in claim 1, wherein the cavity part comprises a first cavity and a second cavity, the port part comprises a first port, a second port, a third port, a fifth port and a sixth port, the resonator comprises a first resonator, a second resonator, a third resonator and a fourth resonator;
wherein the loudspeaker body is provided corresponding to the first cavity, the first cavity is in communication with the first port and the second port, respectively, the first port and the second port are symmetrically arranged at two opposite sides of the third port, the third port is in communication with the second cavity, the fourth port and the fifth port are symmetrically arranged at two opposite sides of the second cavity, and the fifth port and the fourth port are both in communication with the sixth port;
wherein a first side of the first resonator is provided corresponding to the first port, and a second side of the first resonator is provided corresponding to the third port;
wherein a first side of the second resonator is provided corresponding to the second port, and a second side of the second resonator is provided corresponding to the third port;
wherein a first side of the third resonator is provided corresponding to the second cavity, and a second side of the third resonator is provided corresponding to the fourth port; and
a first side of the fourth resonator is provided corresponding to the second cavity, and a second side of the fourth resonator is provided corresponding to the fifth port.

6. The loudspeaker as described in claim 5, wherein the first cavity, the third port, the second cavity, and the sixth port have axes coincide with each other.

7. The loudspeaker as described in claim 1, wherein the preset angle is 90°.

8. The loudspeaker as described in claim 1, wherein a length of the port part in the first direction is less than a length of the port part in the second direction.

9. The loudspeaker as described in claim 1, wherein an arc guide surface is provided on each of two inner surfaces on opposite sides of the port part to form a port part with a Venturi tube structure.

10. An electronic device, comprising the loudspeaker as described in claim 1.
